(19) United States
(12) Patent Application Publication
(10) Pub. No.: US 2025/0007360 A1
(43) Pub. Date: Jan. 2, 2025

(54) ROTARY MACHINE, METHOD FOR MANUFACTURING THE ROTARY MACHINE, AND MAGNETIC SENSOR

(71) Applicant: Panasonic Intellectual Property Management Co., Ltd., Osaka (JP)

(72) Inventors: Noritaka ICHINOMIYA, Nara (JP); Kazuhiro ONAKA, Hyogo (JP)

(21) Appl. No.: 18/695,754

(22) PCT Filed: Sep. 29, 2022
(86) PCT No.: PCT/JP2022/036501

§ 371 Date: Mar. 26, 2024

(30) Foreign Application Priority Data
Sep. 30, 2021 (JP) 2021-162225

(51) Int. Cl. H02K 11/215; H02K 5/22; H02K 15/00

(52) U.S. Cl. CPC H02K 11/215; H02K 5/22; H02K 15/00; H02K 2215/00

(57) ABSTRACT

A rotary machine according to the present disclosure includes a stator, a rotor, a rotary shaft, and a magnetic sensor. The rotor rotates relative to the stator. The rotary shaft is coupled to the rotor and rotates as the rotor rotates. The magnetic sensor detects a position of the rotor. The rotor includes a plurality of magnets. The magnetic sensor is arranged to face the rotor in an axial direction that is parallel to the rotary shaft. The magnetic sensor detects the position of the rotor based on a magnetic field generated by the plurality of magnets of the rotor.

### TECHNICAL FIELD

The present disclosure generally relates to a rotary machine, a method for manufacturing the rotary machine, and a magnetic sensor. More particularly, the present disclosure relates to a rotary machine including a magnetic sensor, a method for manufacturing such a rotary machine including the magnetic sensor, and the magnetic sensor for use in the rotary machine.

### BACKGROUND ART

Patent Literature 1 discloses a rotating electrical machine including a rotor and a stator. The rotor includes a rotor carrier having a generally circular cylindrical shape and an annular magnet unit fixed to the rotor carrier. The stator includes an annular stator core and stator winding assembled on an outer peripheral surface of the stator core. The stator winding faces the magnet unit with a predetermined air gap left between the stator winding and the magnet unit.

In addition, the rotating electrical machine of Patent Literature 1 further includes a hall element arranged to overlap with the magnet unit when viewed in a direction parallel to its rotary shaft and a sensor magnet fixed onto the rotary shaft. The sensor magnet is arranged to be separated from the hall element in the direction parallel to the rotary shaft.

The rotary machine (rotating electrical machine) of Patent Literature 1 needs to include, besides the magnet unit for use to rotate the rotor relative to the stator, a position detecting magnet (sensor magnet) for use to detect the position of the rotor.

### CITATION LIST

### Patent Literature

Patent Literature 1: JP 2021-44948 A

### SUMMARY OF INVENTION

An object of the present disclosure is to provide a rotary machine, for which no position detecting magnets need to be provided, a method for manufacturing such a rotary machine, and a magnetic sensor.

A rotary machine according to an aspect of the present disclosure includes a stator, a rotor, a rotary shaft, and a magnetic sensor. The rotor rotates relative to the stator. The rotary shaft is coupled to the rotor and rotates as the rotor rotates. The magnetic sensor detects a position of the rotor. The rotor includes a plurality of magnets. The magnetic sensor is arranged to face the rotor in an axial direction that is parallel to the rotary shaft. The magnetic sensor detects the position of the rotor based on a magnetic field generated by the plurality of magnets of the rotor.

A method for manufacturing a rotary machine according to another aspect of the present disclosure is a method for manufacturing a rotary machine including a stator, a rotor, a rotary shaft, and a magnetic sensor. The rotor rotates relative to the stator. The rotary shaft is coupled to the rotor and rotates as the rotor rotates. The magnetic sensor detects a position of the rotor. The rotor includes a plurality of magnets. The magnetic sensor detects the position of the rotor based on a magnetic field generated by the plurality of magnets of the rotor. The method for manufacturing the rotary machine includes the step of arranging the magnetic sensor to make the magnetic sensor face the rotor in an axial direction that is parallel to the rotary shaft.

A magnetic sensor according to still another aspect of the present disclosure is designed to be used in a rotary machine including a stator, a rotor, and a rotary shaft. The rotor rotates relative to the stator. The rotary shaft is coupled to the rotor and rotates as the rotor rotates. The rotor includes a plurality of magnets. The magnetic sensor faces the rotor in an axial direction that is parallel to the rotary shaft. The magnetic sensor detects a position of the rotor based on a magnetic field generated by the plurality of magnets of the rotor.

### BRIEF DESCRIPTION OF DRAWINGS

FIG. 1 is a schematic representation illustrating a cross section of a rotary machine according to a first embodiment;

FIG. 2 is a schematic representation illustrating a rotor and a rotary shaft for use in the rotary machine:

FIG. 3 is a schematic representation illustrating an arrangement of a plurality of magnets in the rotor for use in the rotary machine:

FIG. 4 is a circuit diagram illustrating a set of bridge circuits included in a magnetic sensor for use in the rotary machine:

FIG. 5 is a circuit diagram illustrating another set of bridge circuits included in the magnetic sensor for use in the rotary machine:

FIG. 6 is a schematic representation illustrating an installation range for the magnetic sensor for use in the rotary machine:

FIG. 7 is a schematic representation illustrating another installation range for the magnetic sensor for use in the rotary machine:

FIG. 8 shows waveforms detected by the magnetic sensor for use in the rotary machine:

FIG. 9 is a schematic representation illustrating a cross section of a rotary machine according to a second embodiment; and

FIG. 10 is a schematic representation illustrating a cross section of a rotary machine according to a third embodiment.

### DESCRIPTION OF EMBODIMENTS

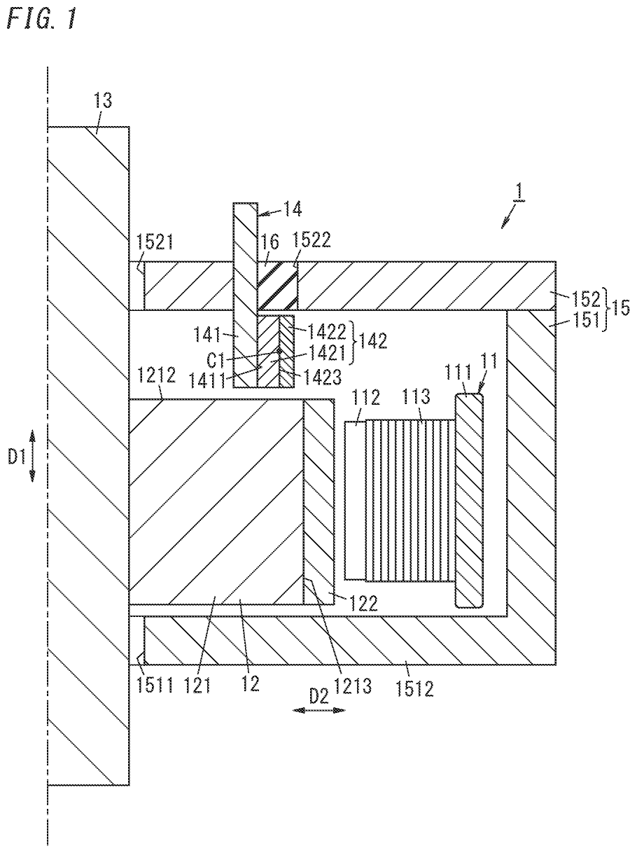

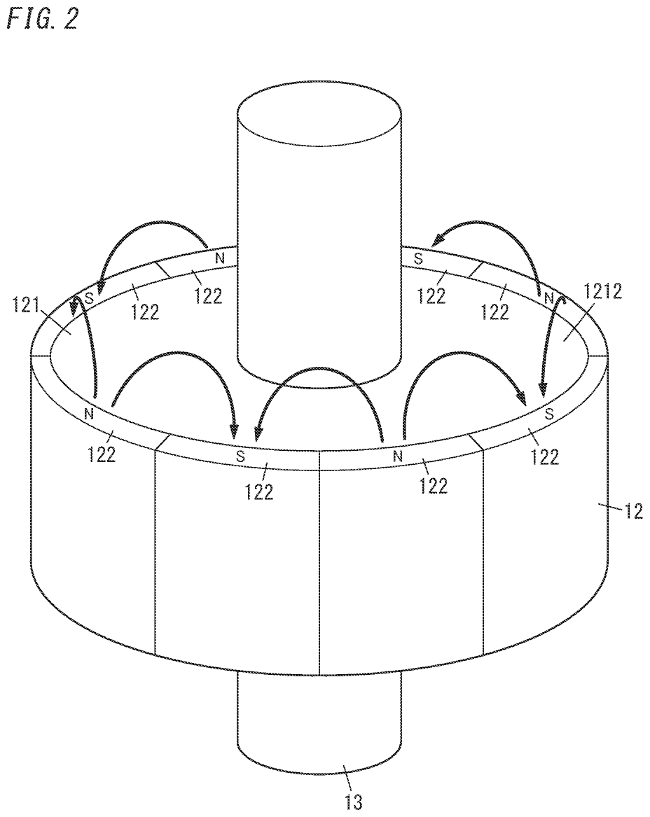

A rotary machine, method for manufacturing the rotary machine, and magnetic sensor according to first, second, and third embodiments will now be described with reference to the accompanying drawings. FIGS. 1-3 and FIGS. 6, 7, 9, and 10 to be referred to in the following description of the first, second, and third embodiments are all schematic representations. Thus, the ratio of the dimensions (including thicknesses) of respective constituent elements illustrated on the drawings does not always reflect their actual dimensional ratio. Note that the first, second, and third embodiments to be described below are only exemplary ones of various embodiments of the present disclosure and should not be construed as limiting. Rather, the exemplary embodiments may be readily modified in various manners depending on a design choice or any other factor without departing from the scope of the present disclosure.

### First Embodiment

A rotary machine 1, method for manufacturing the rotary machine 1, and magnetic sensor 14 according to a first embodiment will now be described with reference to FIGS. 1-8.

### (1) Overview

First, an overview of the rotary machine 1 and magnetic sensor 14 according to the first embodiment will be described with reference to FIG. 1.

The rotary machine 1 according to the first embodiment may be, for example, an onboard rotary machine to be installed in an electric vehicle and may be used as a power source for the electric vehicle. The rotary machine 1 may be, for example, an electric motor (motor). More specifically, the rotary machine 1 may be, for example, a brushless motor. The rotary machine 1 generates motive power (rotational torque) by turning a rotary shaft 13 (refer to FIG. 1) with DC power supplied from a battery (not shown) built in the electric vehicle.

To eliminate the need to provide a position detecting magnet for detecting the position of a rotor 12, the rotary machine 1 and magnetic sensor 14 according to the first embodiment adopt the configuration to be described below.

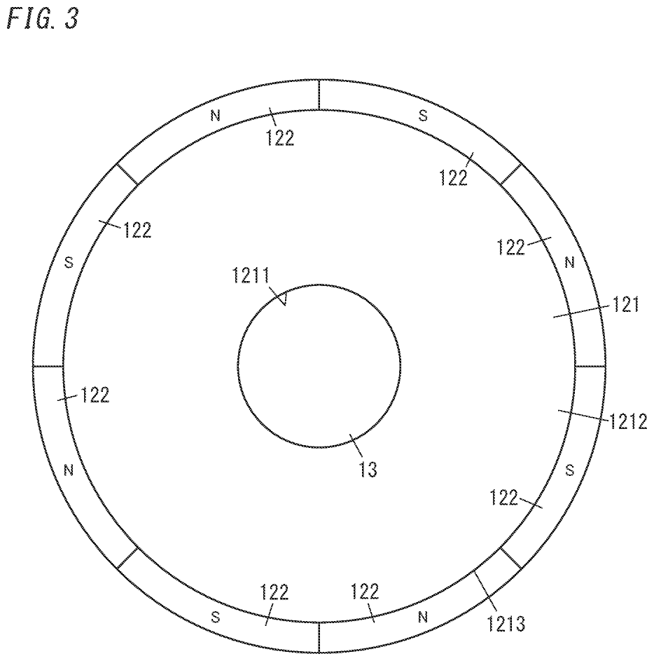

Specifically, the rotary machine 1 according to the first embodiment includes a stator 11, a rotor 12, a rotary shaft 13, and a magnetic sensor 14 as shown in FIG. 1. The rotor 12 rotates relative to the stator 11. The rotary shaft 13 is coupled to the rotor 12 and rotates as the rotor 12 rotates. The magnetic sensor 14 detects the position of the rotor 12. The rotor 12 includes a plurality of magnets 122 (refer to FIG. 3). The magnetic sensor 14 is arranged to face the rotor 12 in an axial direction D1 and detects the position of the rotor 12 based on a magnetic field generated by the plurality of magnets 122 (refer to FIG. 3) of the rotor 12. The axial direction D1 is direction parallel to the longitudinal axis of the rotary shaft 13.

The magnetic sensor 14 according to the first embodiment is designed to be used in a rotary machine 1 including a stator 11, a rotor 12, and a rotary shaft 13 as shown in FIG. 1. The rotor 12 rotates relative to the stator 11. The rotary shaft 13 is coupled to the rotor 12 and rotates as the rotor 12 rotates. The rotor 12 includes a plurality of magnets 122 (refer to FIG. 3). The magnetic sensor 14 faces the rotor 12 in an axial direction D1 and detects the position of the rotor 12 based on a magnetic field generated by the plurality of magnets 122 (refer to FIG. 3) of the rotor 12. The axial direction D1 is a direction parallel to the longitudinal axis of the rotary shaft 13.

In the rotary machine 1 and magnetic sensor 14 according to the first embodiment, the magnetic sensor 14 is arranged to face the rotor 12 in the axial direction D1 and detects the position of the rotor 12 based on a magnetic field generated by the plurality of magnets 122 (refer to FIG. 3) of the rotor 12 as described above. That is why there is no need to provide any position detecting magnets for detecting the position of the rotor 12, thus allowing the position detecting magnets to be omitted. That is to say, there is no need to provide any position detecting magnet besides the plurality of magnets 122 of the rotor 12.

### (2) Details

Next, the rotary machine 1 and magnetic sensor 14 according to the first embodiment will be described in further detail with reference to FIGS. 1-5.

The rotary machine 1 according to the first embodiment includes the stator 11, the rotor 12, the rotary shaft 13, and the magnetic sensor 14 as shown in FIG. 1. The rotary machine 1 according to the first embodiment further includes a housing 15. The rotary machine 1 may be used as, for example, an electric motor (motor) as described above.

### (2.1) Stator

The stator 11 includes a stator core 111, a plurality of teeth 112, and a plurality of coils 113 as shown in FIGS. 1, 6, and 7.

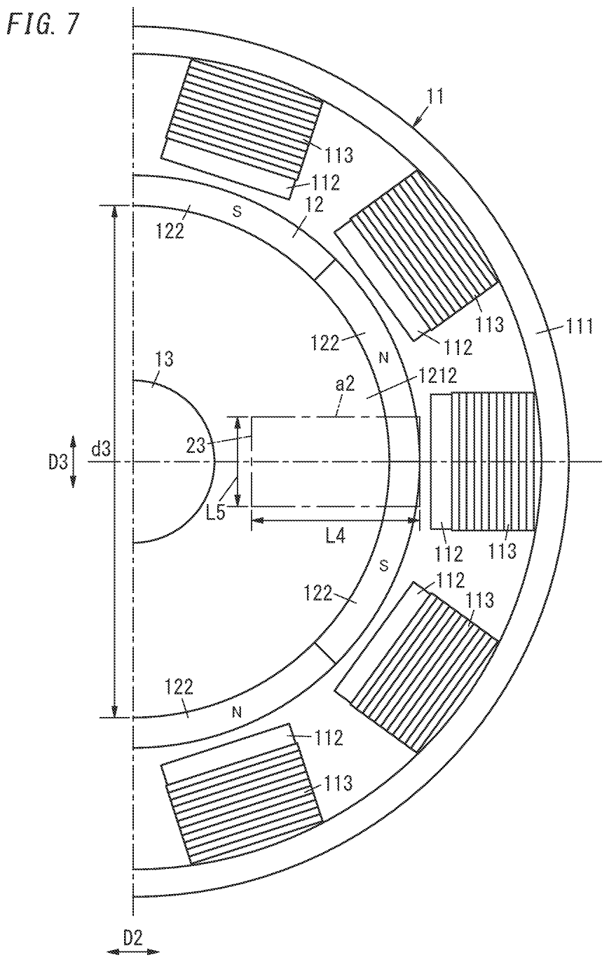

As shown in FIG. 7, the stator core 111 may have, for example, an annular (ringlike) shape when viewed in plan in the axial direction D1. The axial direction D1 is a direction parallel to the rotary shaft 13 (to be described later), i.e., an upward/downward direction shown in FIG. 1. The stator core 111 may be made of a magnetic material such as silicon steel sheets. More specifically, the stator core 111 may be formed by stacking a plurality of silicon steel sheets one on top of another in the thickness direction defined for the stator core 111. Thus, the stator core 111 has a rectangular cross section as taken in a circumferential direction.

Each of the plurality of teeth 112 protrudes from the inner circumferential surface of the stator core 111 toward the center of the stator core 111. The plurality of teeth 112 are arranged at regular intervals along the circumference of the stator core 111. Each of the plurality of teeth 112, as well as the stator core 111, is formed by stacking a plurality of silicon steel sheets one on top of another in the thickness direction. The plurality of teeth 112 may be formed integrally with, or separately from, the stator core 111, whichever is appropriate.

The plurality of coils 113 correspond one to one to the plurality of teeth 112. Each of the plurality of coils 113 is formed by winding a conductive wire around the outer peripheral surface of a corresponding tooth 112 out of the plurality of teeth 112. The winding axis of each of the plurality of coils 113 is aligned with the direction in which the corresponding tooth 112 protrudes.

### (2.2) Rotor

The rotor 12 rotates relative to the stator 11. The rotation of the rotor 12 relative to the stator 11 causes the rotary shaft 13 (to be described later) to rotate as well. That is to say, as the rotor 12 rotates relative to the stator 11, the motive power (rotational torque) is transmitted to the rotary shaft 13.

As shown in FIGS. 1-3, the rotor 12 includes a rotor core 121 and a plurality of (e.g., eight in the example illustrated in FIGS. 1-3) magnets 122.

The rotor core 121 may have, for example, a circular cylindrical shape and is arranged to have its center axis aligned with the axial direction D1. The rotor core 121 may be made of a magnetic material such as silicon steel sheets. More specifically, the rotor core 121 may be formed by stacking a plurality of silicon steel sheets one on top of another in the thickness direction defined for the rotor core 121.

The rotor core 121 has a shaft hole 1211 (refer to FIG. 3). The shaft hole 1211 is provided through a central portion of the rotor core 121 to penetrate through the rotor core 121 in the thickness direction defined for the rotor core 121 (i.e., in the axial direction D1). The inside diameter (diameter) of the shaft hole 1211 is approximately equal to the outside diameter (diameter) of the rotary shaft 13.

Each of the plurality of (e.g., eight in the example illustrated in FIG. 3) magnets 122 may be, for example, a permanent magnet (such as a neodymium magnet). Each of the plurality of magnets 122 may have, for example, an arc shape when viewed in plan in the axial direction D1 (refer to FIG. 3). The plurality of magnets 122 are arranged along the outer peripheral surface 1213 of the rotor core 121 to form an annular (ringlike) pattern when viewed in plan in the axial direction D1. Thus, a plurality of magnetic poles (i.e., S-poles and N-poles) are arranged alternately along the circumference of the rotor core 121.

Each of the plurality of magnets 122 is magnetized along the radius of the rotor core 121. For example, if one magnet 122 out of the plurality of magnets 122 has S-pole as the magnetic pole of the outer part thereof in the radial direction of the rotor core 121, then the inner part of the magnet 122 has N-pole as the magnetic pole thereof. In the rotary machine 1 according to the first embodiment, the plurality of magnets 122 are arranged along the outer peripheral surface (surface) of the rotor core 121. That is to say, the rotary machine 1 according to the first embodiment is a surface permanent magnet (SPM) motor. Note that in FIG. 3, only the magnetic pole of the outer part of each magnet 122 in the radial direction of the rotor core 121 is shown with the magnetic pole of the inner part thereof not shown there.

The rotor 12 having such a configuration is caused to rotate by a magnetic field generated by the plurality of magnets 122 and a magnetic field generated by allowing a current to flow through the plurality of coils 113 of the stator 11 and transmits the torque thus generated (i.e., rotational torque) to the rotary shaft 13.

### (2.3) Rotary Shaft

The rotary shaft 13 may have, for example, the shape of a round rod which is elongate in the axial direction D1 as shown in FIGS. 1-3. The rotary shaft 13 is attached to the rotor core 121 to be inserted into the shaft hole 1211 of the rotor core 121. The rotary shaft 13 rotates as the rotor 12 rotates. That is to say, the rotary shaft 13 is coupled to the rotor 12 and rotates as the rotor 12 rotates.

### (2.4) Magnetic Sensor

The magnetic sensor 14 detects the position of the rotor 12. More specifically, the magnetic sensor 14 detects the position of the rotor 12 based on a magnetic field generated on a counter surface 1212 of the rotor core 121 by the plurality of magnets 122 that are arranged along the outer peripheral surface 1213 of the rotor core 121 of the rotor 12. The counter surface 1212 of the rotor core 121 is a surface, facing the magnetic sensor 14 in the axial direction D1, of the rotor core 121.

The magnetic sensor 14 includes a board 141 and a sensor unit 142 as shown in FIG. 1.

The board 141 may be, for example, a printed wiring board. The board 141 has one surface 1411. The one surface 1411 is a mount surface on which the sensor unit 142 is mounted. The board 141 is fixed to the housing 15 (to be described later) with an appropriate fixing means. Examples of the fixing means include a screw, a double-sided adhesive tape, and a magic tape (R).

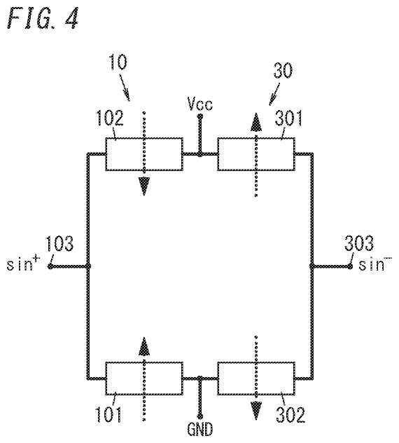

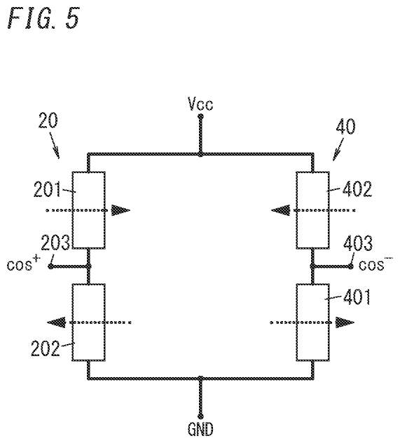

The sensor unit 142 includes a plurality of (e.g., eight in the example illustrated in FIGS. 4 and 5) magnetoresistance effect elements 101, 102, 201, 202, 301, 302, 401, 402 as shown in FIGS. 4 and 5. Each of these magnetoresistance effect elements 101, 102, 201, 202, 301, 302, 401, 402 may be, for example, a giant magnetoresistance effect (GMR) element.

As shown in FIG. 1, the sensor unit 142 includes a base member 1421 and a magnetoresistive film 1422. The magnetoresistive film 1422 is disposed on a surface 1423, opposite from the board 141, of the base member 1421. The magnetoresistive film 1422 forms the magnetoresistance effect elements 101, 102, 201, 202, 301, 302, 401, 402. That is to say, in the rotary machine 1 according to the first embodiment, the surface 1423, opposite from the board 141, of the base member 1421 is the single plane (hereinafter simply referred to as a “plane 1423”) on which the magnetoresistance effect elements 101, 102, 201, 202, 301, 302, 401, 402 are formed. The sensor unit 142 is arranged (mounted) on the one surface 1411 of the board 141 to make the plane 1423 of the base member 1421 parallel to the one surface 1411 of the board 141 as shown in FIG. 1.

The magnetic sensor 14 is mounted onto the housing 15 by fixing the board 141 to the housing 15 in a state where the sensor unit 142 is located inside the housing 15 with the board 141 inserted partially into a through hole 1522 of the housing 15 (to be described later) as shown in FIG. 1. That is to say, in the rotary machine 1 according to the first embodiment, part of the board 141 is exposed outside of the housing 15. In addition, in the state where the magnetic sensor 14 is mounted onto the housing 15, the through hole 1522 is sealed with a sealing member 16. The sealing member 16 may be, for example, a molded product of silicone rubber.

### (2.5) Housing

The housing 15 is a product formed by aluminum die casting, for example. The housing 15 may have, for example, the shape of a hollow circular cylinder. The housing 15 includes a case 151 and a cover 152 as shown in FIG. 1. Each of the case 151 and the cover 152 is a product formed by aluminum die casting.

The case 151 has the shape of a circular cylinder, of which one surface (i.e., the upper surface in FIG. 1) is open. The case 151 has a shaft hole 1511 as shown in FIG. 1. The shaft hole 1511 penetrates through a central part of a bottom panel 1512 of the case 151 in the thickness direction defined for the bottom panel 1512 of the case 151 (i.e., in the axial direction D1). The shaft hole 1511 has a circular shape when viewed in plan in the axial direction D1. The inside diameter (diameter) of the shaft hole 1511 is larger than the outside diameter (diameter) of the rotary shaft 13.

The cover 152 may have, for example, a disklike shape. The cover 152 has a shaft hole 1521 and the through hole 1522 as shown in FIG. 1. The shaft hole 1521 penetrates through a central part of the cover 152 in the thickness direction defined for the cover 152 (i.e., in the axial direction D1). The shaft hole 1521 has a circular shape, and has the same dimension as the shaft hole 1511, when viewed in plan in the axial direction D1.

The through hole 1522 is provided to face the rotor core 121 of the rotor 12 in the axial direction D1. The through hole 1522 penetrates through the cover 152 in the thickness direction defined for the cover 152 (i.e., in the axial direction D1). The through hole 1522 may have, for example, a rectangular shape when viewed in plan in the axial direction D1. The through hole 1522 is large enough to allow the magnetic sensor 14 to be inserted therethrough. Thus, the rotary machine 1 according to the first embodiment allows the magnetic sensor 14 to be mounted onto the housing 15 after the stator 11, the rotor 12, and the rotary shaft 13 have been assembled together to the housing 15. That is to say, this embodiment allows the magnetic sensor 14 to be mounted onto the rotary machine 1 that has been assembled as a final product.

The housing 15 may be assembled integrally by attaching the cover 152 to the case 151 to close the upper opening of the case 151.

The case 151 and the cover 152 that have been assembled together, i.e., the housing 15, houses at least the stator 11 and the rotor 12. More specifically, the housing 15 houses the stator 11, the rotor 12, a part of the rotary shaft 13, and a part of the magnetic sensor 14 as shown in FIG. 1.

The housing 15 rotatably holds, via a plurality of bearings (not shown), the rotary shaft 13, which is partially exposed through the shaft hole 1511 of the case 151 and the shaft hole 1521 of the cover 152.

### (3) Circuit Configuration for Magnetic Sensor

Next, a circuit configuration for the magnetic sensor 14 will be described with reference to FIGS. 4 and 5.

The magnetic sensor 14 includes a first half-bridge circuit 10, a second half-bridge circuit 20, a third half-bridge circuit 30, and a fourth half-bridge circuit 40 as shown in FIGS. 4 and 5. The first half-bridge circuit 10 includes a pair of magnetoresistance effect elements 101, 102 and a first output terminal 103 as shown in FIG. 4. The pair of magnetoresistance effect elements 101, 102 detects a magnetic field oriented in a first direction (i.e., the upward/downward direction in FIG. 4). The first direction is a direction perpendicular to the plane 1423 of the base member 1421 of the magnetic sensor 14. The first output terminal 103 delivers a first output signal from a node of connection between the pair of magnetoresistance effect elements 101, 102. The first output signal may be, for example, a sinusoidal wave signal.

The second half-bridge circuit 20 includes a pair of magnetoresistance effect elements 201, 202 and a second output terminal 203 as shown in FIG. 5. The pair of magnetoresistance effect elements 201, 202 detects a magnetic field oriented in a second direction (i.e., the rightward/leftward direction in FIG. 5). The second direction is a direction perpendicular to not only the plane 1423 of the base member 1421 of the magnetic sensor 14 but also the first direction. The second output terminal 203 delivers a second output signal from a node of connection between the pair of magnetoresistance effect elements 201, 202. The second output signal may be, for example, a cosine wave signal.

The third half-bridge circuit 30 includes a pair of magnetoresistance effect elements 301, 302 and a third output terminal 303 as shown in FIG. 4. The pair of magnetoresistance effect elements 301, 302 detects a magnetic field oriented in the first direction. The magnetoresistance effect element 301 having the higher potential out of the pair of magnetoresistance effect elements 301, 302 detects a magnetic field which is antiparallel to the magnetic field detected by the magnetoresistance effect element 102 having the higher potential out of the pair of magnetoresistance effect elements 101, 102. The magnetoresistance effect element 302 having the lower potential out of the pair of magnetoresistance effect elements 301, 302 detects a magnetic field which is antiparallel to the magnetic field detected by the magnetoresistance effect element 101 having the lower potential out of the pair of magnetoresistance effect elements 101, 102. The third output terminal 303 delivers a third output signal from a node of connection between the pair of magnetoresistance effect elements 301, 302. The third output signal may be, for example, a sinusoidal wave signal and have an opposite phase from the first output signal.

The fourth half-bridge circuit 40 includes a pair of magnetoresistance effect elements 401, 402 and a fourth output terminal 403 as shown in FIG. 5. The pair of magnetoresistance effect elements 401, 402 detects a magnetic field oriented in the second direction. The magnetoresistance effect element 402 having the higher potential out of the pair of magnetoresistance effect elements 401, 402 detects a magnetic field which is antiparallel to the magnetic field detected by the magnetoresistance effect element 201 having the higher potential out of the pair of magnetoresistance effect elements 201, 202. The magnetoresistance effect element 401 having the lower potential out of the pair of magnetoresistance effect elements 401, 402 detects a magnetic field which is antiparallel to the magnetic field detected by the magnetoresistance effect element 202 having the lower potential out of the pair of magnetoresistance effect elements 201, 202. The fourth output terminal 403 delivers a fourth output signal from a node of connection between the pair of magnetoresistance effect elements 401, 402. The fourth output signal may be, for example, a cosine wave signal and have an opposite phase from the second output signal.

That is to say, in the rotary machine 1 according to the first embodiment, the pair of magnetoresistance effect elements 101, 102 and the pair of magnetoresistance effect elements 301, 302 serve as the first magnetoresistance effect element. Also, in the rotary machine 1 according to the first embodiment, the pair of magnetoresistance effect elements 201, 202 and the pair of magnetoresistance effect elements 401, 402 serve as the second magnetoresistance effect element.

As shown in FIG. 4, a first terminal of the magnetoresistance effect element 101 is connected to the ground. A second terminal of the magnetoresistance effect element 101 is connected to a first terminal of the magnetoresistance effect element 102. A second terminal of the magnetoresistance effect element 102 is connected to a power supply (Vcc). That is to say, the pair of magnetoresistance effect elements 101, 102 are connected in series between the power supply and the ground.

As shown in FIG. 5, a first terminal of the magnetoresistance effect element 201 is connected to the power supply (Vcc). A second terminal of the magnetoresistance effect element 201 is connected to a first terminal of the magnetoresistance effect element 202. A second terminal of the magnetoresistance effect element 202 is connected to the ground. That is to say, the pair of magnetoresistance effect elements 201, 202 are connected in series between the power supply and the ground.

As shown in FIG. 4, a first terminal of the magnetoresistance effect element 301 is connected to the power supply (Vcc). A second terminal of the magnetoresistance effect element 301 is connected to a first terminal of the magnetoresistance effect element 302. A second terminal of the magnetoresistance effect element 302 is connected to the ground. That is to say, the pair of magnetoresistance effect elements 301, 302 are connected in series between the power supply and the ground.

As shown in FIG. 5, a first terminal of the magnetoresistance effect element 401 is connected to the ground. A second terminal of the magnetoresistance effect element 401 is connected to a first terminal of the magnetoresistance effect element 402. A second terminal of the magnetoresistance effect element 402 is connected to the power supply (Vcc). That is to say, the pair of magnetoresistance effect elements 401, 402 are connected in series between the power supply and the ground.

The first output signal delivered from the first output terminal 103, the second output signal delivered from the second output terminal 203, the third output signal delivered from the third output terminal 303, and the fourth output signal delivered from the fourth output terminal 403 are all supplied to a processing circuit (not shown). The processing circuit includes a computer system including one or more processors and a memory. The functions of the processing circuit are performed by making the processor of the computer system execute a program stored in the memory of the computer system. The program may be stored in the memory. Alternatively, the program may also be downloaded via a telecommunications line such as the Internet or distributed after having been stored in a non-transitory storage medium such as a memory card.

The processing circuit may be mounted, for example, on the board 141 of the magnetic sensor 14. The processing circuit determines, based on the first, second, third, and fourth output signals, the orientation of the magnetic field applied to the magnetic sensor 14.

### (4) Disposition of Magnetic Sensor

Next, the disposition of the magnetic sensor 14 will be described with reference to FIGS. 1, 6, and 7.

The magnetic sensor 14 is mounted onto the housing 15 by fixing the board 141 to the housing 15 in a state where the sensor unit 142 is located inside the housing 15 with the board 141 inserted partially into the through hole 1522 of the housing 15 as described above. That is to say, the magnetic sensor 14 is mounted onto the housing 15 such that part of the magnetic sensor 14 is located inside the housing 15 and the rest of the magnetic sensor 14 is located outside the housing 15. In such a state where the magnetic sensor 14 is mounted onto the housing 15, the magnetic sensor 14 faces the rotor core 121 of the rotor 12 in the axial direction D1 as shown in FIG. 1. In addition, in the state where the magnetic sensor 14 is mounted onto the housing 15, the counter surface 1212, facing the magnetic sensor 14, of the rotor 12 and the plane 1423 of the base member 1421 of the sensor unit 142 of the magnetic sensor 14 are perpendicular to each other. As used herein, if two things “are perpendicular to each other,” this expression refers to not only a situation where the angle formed between the two things is exactly 90 degrees but also a situation where the difference of the angle formed between the two things from 90 degrees falls within a tolerance range (e.g., ±5 degrees) where substantially the same advantage is achievable.

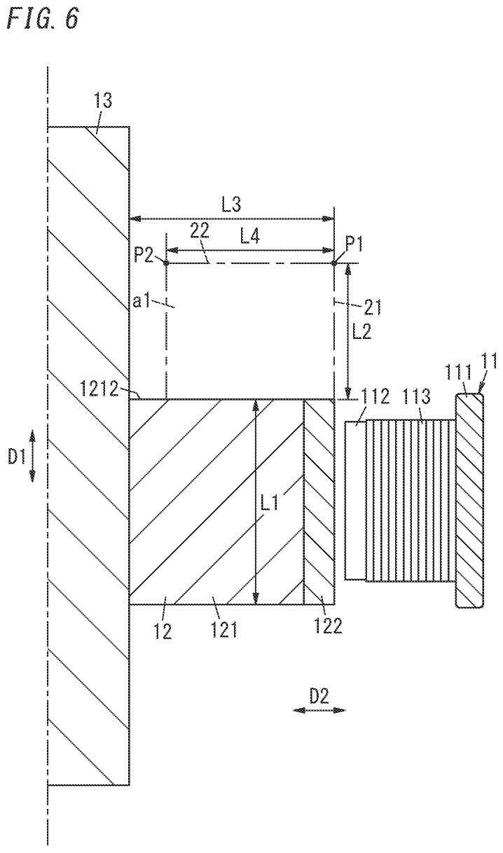

In this embodiment, the center C1 (refer to FIG. 1) of the sensor unit 142 of the magnetic sensor 14 preferably falls within both the area a1 shown in FIG. 6 and the area a2 shown in FIG. 7. As used herein, the center C1 refers to the center of the plane 1423 of the base member 1421 that forms part of the sensor unit 142.

The area a1 herein refers to an area surrounded with a first line segment 21 aligned with the axial direction D1 and a second line segment 22 aligned with the orthogonal direction D2 when viewed in plan in a direction that is perpendicular to both the axial direction D1 and the orthogonal direction D2 (i.e., when viewed along a normal to the paper on which FIG. 6 is drawn) as shown in FIG. 6. The first line segment 21 is 0.8 times as long as a first value L1, which is supposed to be an external dimension (height) of the rotor core 121 of the rotor 12 as measured in the axial direction D1. In other words, the first line segment 21 is a line segment that connects, in the axial direction D1, an outer edge of the counter surface 1212, facing the magnetic sensor 14, of the rotor core 121 of the rotor 12 to a first position P1, where the distance as measured from the outer edge is equal to L2.

On the other hand, the second line segment 22 is 0.8 times as long as a second value L3, which is a distance as measured in the orthogonal direction D2 from the outer edge of the counter surface 1212 to the rotary shaft 13. In other words, the second line segment 22 is a line segment that connects, in the orthogonal direction D2, the first position P1 to a second position P2 where the distance as measured from the first position P1 is equal to L4.

On the other hand, the area a2 herein refers to a rectangular area surrounded with the second line segment 22 aligned with the orthogonal direction D2 and a third line segment 23 aligned with a direction D3 which is perpendicular to both the axial direction D1 and the orthogonal direction D2 when viewed in plan in the axial direction D1 (i.e., when viewed along a normal to the paper on which FIG. 7 is drawn) as shown in FIG. 7. The third line segment 23 is 0.2 times as long as a third value d3, which is the diameter of the rotor core 121 of the rotor 12.

Setting the center C1 of the sensor unit 142 of the magnetic sensor 14 within both the area a1 and the area a2 may further improve the detection accuracy of the magnetic sensor 14.

### (5) Method for Manufacturing Rotary Machine

Next, a method for manufacturing the rotary machine 1 according to the first embodiment will be described.

A method for manufacturing a rotary machine 1 according to the first embodiment is a method for manufacturing a rotary machine 1 including a stator 11, a rotor 12, a rotary shaft 13, and a magnetic sensor 14. The rotor 12 rotates relative to the stator 11. The rotary shaft 13 is coupled to the rotor 12 and rotates as the rotor 12 rotates. The magnetic sensor 14 detects a position of the rotor 12. The rotor 12 includes a plurality of magnets 122. The magnetic sensor 14 detects the position of the rotor 12 based on a magnetic field generated by the plurality of magnets 122 of the rotor 12. The method for manufacturing the rotary machine 1 includes the step of arranging the magnetic sensor 14 to make the magnetic sensor 14 face the rotor 12 in an axial direction D1. The axial direction D1 is a direction parallel to the rotary shaft 13.

In the method for manufacturing the rotary machine 1 according to the first embodiment, the magnetic sensor 14 is arranged to face the rotor 12 in the axial direction D1. The magnetic sensor 14 thus arranged may detect the position of the rotor 12 based on a magnetic field generated by the plurality of magnets 122 of the rotor 12. This eliminates the need to provide any position detecting magnets for detecting the position of the rotor 12, thus allowing the position detecting magnet to be omitted.

Next, a specific method for manufacturing the rotary machine 1 will be described.

First, the worker performs a first attaching process step of attaching the rotary shaft 13 onto the rotor 12. More specifically, the worker performs the first attaching process step by inserting the rotary shaft 13 into the shaft hole 1211 provided through the rotor core 121 of the rotor 12 and then attaching the rotary shaft 13 onto the rotor core 121 using an appropriate mounting means.

Next, the worker performs a housing process step of housing the stator 11, the rotor 12, and the rotary shaft 13 in the case 151 of the housing 15. More specifically, the worker performs the housing process step by inserting a first end portion (i.e., the lower end portion in FIG. 1) of the rotary shaft 13 into the shaft hole 1511 provided through the case 151 of the housing 15 and thereby housing the rotor 12 and the rotary shaft 13 in the case 151. In addition, the worker also performs the housing process step by housing the stator 11 in the case 151 such that the stator 11 surrounds the rotor 12 and the rotary shaft 13.

Subsequently, the worker performs a second attaching process step of attaching the cover 152 onto the case 151. More specifically, the worker performs the second attaching process step of attaching the cover 152 onto the case 151 by inserting a second end portion (i.e., the upper end portion in FIG. 1) of the rotary shaft 13 into the shaft hole 1521 provided through the cover 152 and then bringing the cover 152 closer toward the case 151.

Thereafter, the worker performs a third attaching process step of attaching the magnetic sensor 14 into the rotary machine 1 that has been assembled integrally. More specifically, the worker performs the third attaching process step by inserting a part of the board 141 of the magnetic sensor 14 into the housing 15 through the through hole 1522 provided through the cover 152 of the housing 15. Thereafter, the worker secures the board 141 onto the cover 152 of the housing 15 using a double-sided adhesive tape, for example. At this time, the magnetic sensor 14 faces the rotor 12 in the axial direction D1 as shown in FIG. 1. That is to say, the method for manufacturing the rotary machine 1 includes the step of arranging the magnetic sensor 14 to make the magnetic sensor 14 face the rotor 12 in the axial direction D1. Finally, the worker seals, with the sealing member 16, the through hole 1522 provided through the cover 152 of the housing 15 to finish assembling the rotary machine 1.

### (6) Characteristics of Magnetic Sensor

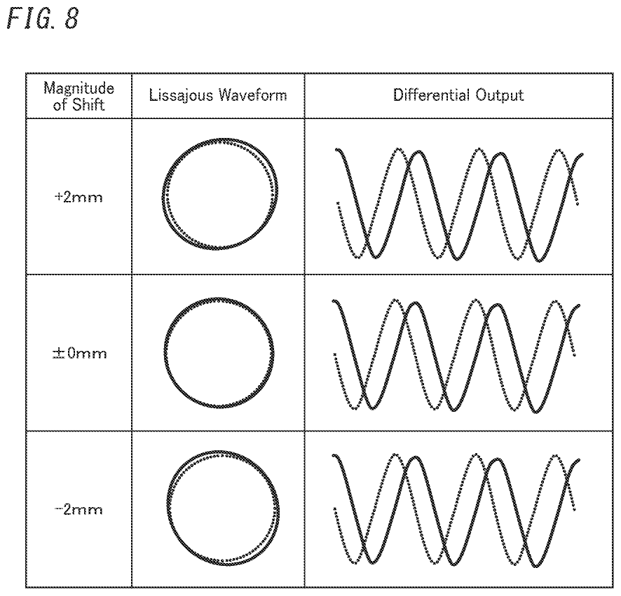

Next, the characteristics of the magnetic sensor 14 will be described with reference to FIG. 8.

If the magnetic sensor 14 is located at a predetermined reference position in the axial direction D1 (i.e., if the magnitude of shift thereof is +0 mm), then the magnetic field detected by the magnetic sensor 14 has a substantially ideal waveform with almost no phase shift from the ideal waveform as indicated by Lissajous waveforms. In addition, in that case, the magnetic field detected by the magnetic sensor 14 has hardly distorted sinusoidal and cosine waveforms as indicated by differential output waveforms.

If the magnetic sensor 14 has shifted by 2 mm upward of the reference position in the axial direction D1, then the magnetic field detected by the magnetic sensor 14 has a waveform with an insignificant phase shift from the ideal waveform as indicated by Lissajous waveforms. In addition, in that case, the magnetic field detected by the magnetic sensor 14 has hardly distorted sinusoidal and cosine waveforms as indicated by differential output waveforms.

If the magnetic sensor 14 has shifted by 2 mm downward of the reference position in the axial direction D1, then the magnetic field detected by the magnetic sensor 14 has a waveform with an insignificant phase shift from the ideal waveform as indicated by Lissajous waveforms. In addition, in that case, the magnetic field detected by the magnetic sensor 14 has hardly distorted sinusoidal and cosine waveforms as indicated by differential output waveforms.

As can be seen, as long as the position of the magnetic sensor 14 in the axial direction D1 falls within +2 mm range from the reference position, waveforms (i.e., sinusoidal and cosine waveforms) with insignificant phase shift and distortion may be obtained.

On the other hand, although not shown, if the magnetic sensor (the sensor unit thereof, strictly speaking) were arranged to face the stator 11 in the axial direction D1, then the waveform of the magnetic field detected by the magnetic sensor 14 would have significantly increased phase shift from the ideal waveform in the Lissajous waveforms and would have significantly more distorted sinusoidal and cosine waveforms as the differential output waveforms. Furthermore, although not shown, if the magnetic sensor (the sensor unit thereof, strictly speaking) were disposed alongside of the stator 11 in the radial direction of the rotor 12, then the waveform of the magnetic field detected by the magnetic sensor 14 would also have significantly increased phase shift from the ideal waveform in the Lissajous waveforms and would also have significantly more distorted sinusoidal and cosine waveforms as the differential output waveforms.

### (7) Advantages

In the rotary machine 1 according to the first embodiment, the magnetic sensor 14 is arranged to face the rotor 12 in the axial direction D1. The magnetic sensor 14 may detect the position of the rotor 12 based on a magnetic field generated by the plurality of magnets 122 of the rotor 12. This eliminates the need to provide any position detecting magnets for detecting the position of the rotor 12, thus allowing the position detecting magnets to be omitted. In addition, in the rotary machine 1 according to the first embodiment, the magnetic sensor 14 detects the magnetic field generated by the plurality of magnets 122 of the rotor 12 that forms part of the rotary machine 1, and therefore, may reduce the effect caused by disturbance. Furthermore, the configuration for the rotary machine 1 according to the first embodiment is applicable to multiple types of rotary machines 1.

In addition, in the rotary machine 1 according to the first embodiment, the counter surface 1212 of the rotor 12 and the plane 1423 of the magnetic sensor 14 are perpendicular to each other. This allows the magnetic field generated by the plurality of magnets 122 of the rotor 12 to be detected as at least one of a sinusoidal wave or a cosine wave.

Furthermore, in the rotary machine 1 according to the first embodiment, the magnetic sensor 14 includes the magnetoresistance effect elements 101, 102, 301, 302 for detecting a magnetic field oriented in the first direction and the magnetoresistance effect elements 201, 202, 401, 402 for detecting a magnetic field oriented in the second direction. This allows both the magnetic field oriented in the first direction and the magnetic field oriented in the second direction to be detected.

Besides, in the rotary machine 1 according to the first embodiment, the magnetic sensor 14 is mounted onto the housing 15 by fixing the board 141 to the housing 15 in a state where the sensor unit 142 is located inside the housing 15 with the board 141 inserted partially into the through hole 1522 of the housing 15. This allows the magnetic sensor 14 to be mounted onto the rotary machine 1 that has been assembled as a final product.

Moreover, the rotary machine 1 according to the first embodiment includes the sealing member 16 for sealing the through hole 1522 in a state where the magnetic sensor 14 is mounted onto the housing 15. This reduces the chances of foreign particles entering the housing 15.

### (8) Variations

Note that the first embodiment described above is only an exemplary one of various embodiments of the present disclosure and should not be construed as limiting. Rather, the first embodiment may be readily modified in various manners depending on a design choice or any other factor without departing from the scope of the present disclosure. Next, variations of the first embodiment will be enumerated one after another. Note that the variations to be described below may be adopted in combination as appropriate.

In the first embodiment, the rotary machine 1 is an electric motor (motor). However, the rotary machine 1 does not have to be an electric motor but may also be a generator, for example. That is to say, the rotary machine 1 may be either an electric motor or a generator, whichever is appropriate.

In the first embodiment, the rotary machine 1 is an SPM motor. However, the rotary machine 1 does not have to be an SPM motor but may also be an interior permanent magnet (IPM) motor, for example. That is to say, the plurality of magnets 122 may also be embedded in the rotor core 121 of the rotor 12.

In the first embodiment, each of the plurality of magnets 122 has an arc shape. However, each of the plurality of magnets 122 does not have to have the arc shape but may also have a flat plate shape, for example.

In the first embodiment, each of the plurality of magnets 122 is a permanent magnet. However, each of the plurality of magnets 122 does not have to be a permanent magnet but may also be an electromagnet, for example.

In the first embodiment, the number of the plurality of magnets 122 is eight. However, the number of the plurality of magnets 122 does not have to be eight but may also be four or twelve, for example.

In the first embodiment, each of the plurality of magnets 122 has two magnetic poles thereof magnetized along the radius of the rotor core 121. However, this is only an example and should not be construed as limiting. Of the two magnetic poles, only the outer magnetic pole needs to be magnetized and the inner magnetic pole does not have to be magnetized.

In the first embodiment, each of the plurality of magnetoresistance effect elements 101, 102, 201, 202, 301, 302, 401, 402 is a giant magnetoresistance effect element. However, each of the plurality of magnetoresistance effect elements 101, 102, 201, 202, 301, 302, 401, 402 does not have to be a giant magnetoresistance effect element but may also be a tunnel magnetoresistance effect (TMR) element, for example. That is to say, each of the plurality of magnetoresistance effect elements 101, 102, 201, 202, 301, 302, 401, 402 may be either a giant magnetoresistance effect element or a tunnel magnetoresistance effect element, whichever is appropriate. Still alternatively, each of the plurality of magnetoresistance effect elements 101, 102, 201, 202, 301, 302, 401, 402 may also be an anisotropic magnetoresistance effect (AMR) element, for example.

In the first embodiment, the sealing member 16 is a molded product of silicone rubber. Alternatively, the sealing member 16 may also be a resin molded product, for example. Even in that case, sealing the through hole 1522 with the sealing member 16 may also reduce the chances of foreign particles entering the housing 15.

In the first embodiment, the stator core 111 is formed as an integral member. However, the stator core 111 does not have to be formed as an integral member but may also be made up of a plurality of divided pieces.

In the first embodiment, the through hole 1522 is provided through the cover 152 of the housing 15. Alternatively, the through hole may also be provided through, for example, the bottom panel 1512 of the case 151 of the housing 15. Even in that case, the through hole may be provided through a part, facing the rotor core 121 in the axial direction D1, of the bottom panel 1512 of the case 151 to make the sensor unit 142 of the magnetic sensor 14 and the rotor core 121 of the rotor 12 face each other in the axial direction D1.

In the first embodiment, the magnetic sensor 14 includes the first half-bridge circuit 10, the second half-bridge circuit 20, the third half-bridge circuit 30, and the fourth half-bridge circuit 40. However, the third half-bridge circuit 30 and the fourth half-bridge circuit 40 may be omitted. That is to say, the magnetic sensor 14 has only to include at least the first half-bridge circuit 10 and the second half-bridge circuit 20.

### Second Embodiment

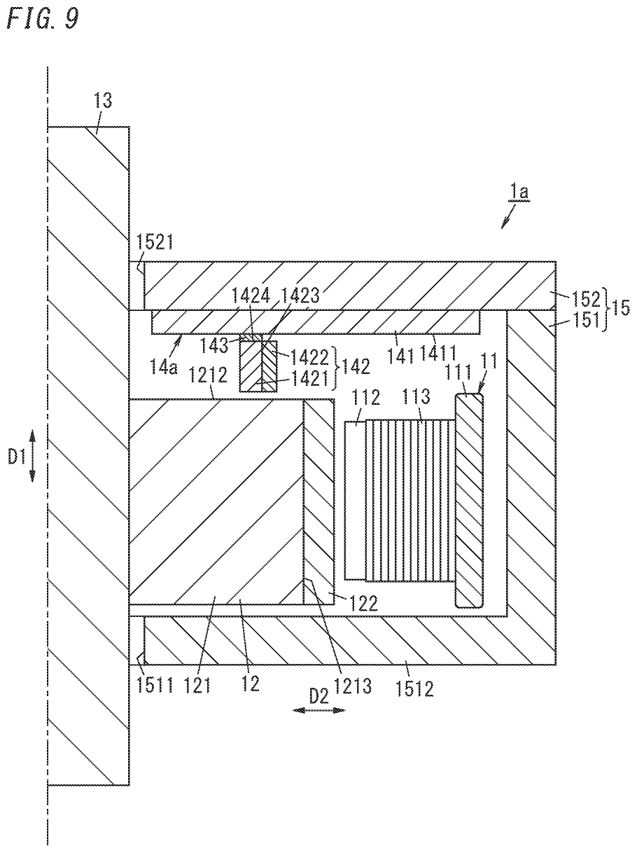

A rotary machine 1a according to a second embodiment will be described with reference to FIG. 9. In the following description, any constituent element of the rotary machine 1a according to this second embodiment, having the same function as a counterpart of the rotary machine 1 (refer to FIG. 1) according to the first embodiment described above, will be designated by the same reference numeral as that counterpart's, and description thereof will be omitted herein.

In the rotary machine 1a according to the second embodiment, the magnetic sensor 14a is housed in its entirety in the housing 15 as shown in FIG. 9, which is a difference from the rotary machine 1 (refer to FIG. 1) according to the first embodiment. In addition, in the rotary machine 1a according to the second embodiment, the magnetic sensor 14a is mounted on the one surface 1411 of the board 141 via an electrode portion 143 provided on a side surface 1424 of the sensor unit 142, which is another difference from the rotary machine 1 according to the first embodiment.

The rotary machine 1a according to the second embodiment includes the stator 11, the rotor 12, the rotary shaft 13, the magnetic sensor 14a, and the housing 15 as shown in FIG. 9. The magnetic sensor 14a includes the board 141 and the sensor unit 142.

The sensor unit 142 includes not only the plurality of magnetoresistance effect elements 101, 102, 201, 202, 301, 302, 401, 402 (refer to FIGS. 4 and 5) arranged on the plane 1423 of the base member 1421 but also the electrode portion 143 that electrically connects the sensor unit 142 and the board 141 to each other. The electrode portion 143 may be solder, for example. The electrode portion 143 is provided on the side surface 1424 of the base member 1421. The side surface 1424 of the base member 1421 extends from the outer edge of the plane 1423 of the base member 1421 in a direction intersecting (at right angles) with the plane 1423. As shown in FIG. 9, the sensor unit 142 is connected to the board 141 via the electrode portion 143.

In this embodiment, in the state where the magnetic sensor 14 is housed in the housing 15, the board 141 of the magnetic sensor 14 is arranged to be parallel to the counter surface 1212, facing the magnetic sensor 14, of the rotor 12 as shown in FIG. 9. Thus, the plane 1423 of the base member 1421 that forms part of the sensor unit 142 of the magnetic sensor 14 is perpendicular to the counter surface 1212.

In the rotary machine 1a according to the second embodiment, as well as the rotary machine 1 according to the first embodiment, the magnetic sensor 14a also faces the rotor 12 in the axial direction D1 and detects the position of the rotor 12 based on the magnetic field generated by the plurality of magnets 122 of the rotor 12. This eliminates the need to provide any position detecting magnets for detecting the position of the rotor 12, thus allowing the position detecting magnets to be omitted.

In addition, in the rotary machine 1a according to the second embodiment, the counter surface 1212 of the rotor 12 and the plane 1423 of the magnetic sensor 14a are perpendicular to each other. This allows the magnetic field generated by the plurality of magnets 122 of the rotor 12 to be detected as at least one of a sinusoidal wave or a cosine wave.

The various configurations described for the second embodiment may be adopted as appropriate in combination with the various configurations (including variations) described above for the first embodiment.

### Third Embodiment

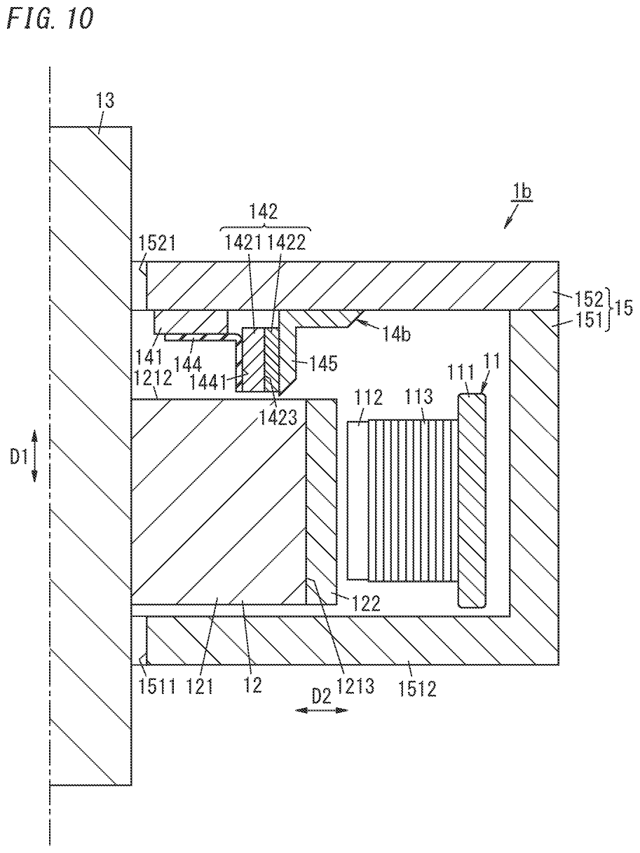

A rotary machine 1b according to a third embodiment will be described with reference to FIG. 10. In the following description, any constituent element of the rotary machine 1b according to this third embodiment, having the same function as a counterpart of the rotary machine 1 (refer to FIG. 1) according to the first embodiment described above, will be designated by the same reference numeral as that counterpart's, and description thereof will be omitted herein.

In the rotary machine 1b according to the third embodiment, the magnetic sensor 14b is housed in its entirety in the housing 15 as shown in FIG. 10, which is a difference from the rotary machine 1 (refer to FIG. 1) according to the first embodiment. In addition, in the rotary machine 1b according to the third embodiment, the sensor unit 142 is held between a first board 144 and a holding member 145, which is another difference from the rotary machine 1b according to the first embodiment.

The rotary machine 1b according to the third embodiment includes the stator 11, the rotor 12, the rotary shaft 13, the magnetic sensor 14b, and the housing 15 as shown in FIG. 10. The magnetic sensor 14b includes the two boards 141, 144, the sensor unit 142, and the holding member 145. That is to say, the rotary machine 1b according to the third embodiment further includes the holding member 145 for holding the magnetic sensor 14b.

The board 144 is a flexible board having flexibility in the thickness direction defined for the board 144 itself. The board 144 has one surface 1441. The board 144 is connected to the board 141. That is to say, in the rotary machine 1b according to the third embodiment, the board 144 is a first board and the board 141 is a second board.

The holding member 145 is formed out of, for example, an electrically insulating material (such as a synthetic resin) to have an L-cross-sectional shape. The holding member 145 is a member for holding the sensor unit 142 between the board 144 and the holding member 145 itself. That is to say, the holding member 145 holds the sensor unit 142 between the board 144, which is folded to have an L-cross section, and the holding member 145 itself as shown in FIG. 10. More specifically, the holding member 145 and the board (first board) 144 hold the sensor unit 142 to sandwich the sensor unit 142 in the orthogonal direction D2. As used herein, the orthogonal direction D2 refers to a direction perpendicular to the axial direction D1. In such a state where the sensor unit 142 is held by the holding member 145 and the board 144, the counter surface 1212, facing the magnetic sensor 14b, of the rotor 12 and the plane 1423 of the base member 1421 of the sensor unit 142 are perpendicular to each other.

In the rotary machine 1b according to the third embodiment, as well as the rotary machine 1 according to the first embodiment, the magnetic sensor 14a also faces the rotor 12 in the axial direction D1 and detects the position of the rotor 12 based on the magnetic field generated by the plurality of magnets 122 of the rotor 12. This eliminates the need to provide any position detecting magnets for detecting the position of the rotor 12, thus allowing the position detecting magnets to be omitted.

In addition, in the rotary machine 1b according to the third embodiment, the counter surface 1212 of the rotor 12 and the plane 1423 of the magnetic sensor 14b are perpendicular to each other. This allows the magnetic field generated by the plurality of magnets 122 of the rotor 12 to be detected as at least one of a sinusoidal wave or a cosine wave.

The various configurations described for the third embodiment may be adopted as appropriate in combination with the various configurations (including variations) described above for the first and second embodiments.

### (Aspects)

The foregoing description of embodiments and their variations provides specific implementations of the following aspects of the present disclosure.

A rotary machine (1; 1a: 1b) according to a first aspect includes a stator (11), a rotor (12), a rotary shaft (13), and a magnetic sensor (14; 14a: 14b). The rotor (12) rotates relative to the stator (11). The rotary shaft (13) is coupled to the rotor (12) and rotates as the rotor (12) rotates. The magnetic sensor (14; 14a; 14b) detects a position of the rotor (12). The rotor (12) includes a plurality of magnets (122). The magnetic sensor (14; 14a; 14b) is arranged to face the rotor (12) in an axial direction (D1) that is parallel to the rotary shaft (13). The magnetic sensor (14; 14a; 14b) detects the position of the rotor (12) based on a magnetic field generated by the plurality of magnets (122) of the rotor (12).

According to this aspect, the magnetic sensor (14; 14a; 14b) detects the position of the rotor (12) based on the magnetic field generated by the plurality of magnets (122) of the rotor (12), thus eliminating the need to provide any position detecting magnets.

In a rotary machine (1; 1a; 1b) according to a second aspect, which may be implemented in conjunction with the first aspect, the magnetic sensor (14; 14a: 14b) includes at least one magnetoresistance effect element (101, 102, 201, 202, 301, 302, 401, 402) disposed on a single plane (1423) of the magnetic sensor (14; 14a: 14b). In this rotary machine (1; 1a: 1b), a counter surface (1212), facing the magnetic sensor (14; 14a: 14b), of the rotor (12) and the single plane (1423) of the magnetic sensor (14; 14a: 14b) are perpendicular to each other.

According to this aspect, the counter surface (1212) of the rotor (12) and the single plane (1423) of the magnetic sensor (14; 14a: 14b) are perpendicular to each other, thus allowing the magnetic field generated by the plurality of magnets (122) of the rotor (12) to be detected as either a sinusoidal wave or a cosine wave.

A rotary machine (1; 1a; 1b) according to a third aspect, which may be implemented in conjunction with the second aspect, includes a plurality of the magnetoresistance effect elements (101, 102, 201, 202, 301, 302, 401, 402). The plurality of the magnetoresistance effect elements (101, 102, 201, 202, 301, 302, 401, 402) includes a first magnetoresistance effect element (101, 102, 301, 302) and a second magnetoresistance effect element (201, 202, 401, 402). The first magnetoresistance effect element (101, 102, 301, 302) detects a magnetic field oriented in a first direction that is perpendicular to the single plane (1423) of the magnetic sensor (14; 14a: 14b). The second magnetoresistance effect element (201, 202, 401, 402) detects a magnetic field oriented in a second direction that is perpendicular to not only the single plane (1423) of the magnetic sensor (14; 14a: 14b) but also the first direction.

This aspect allows both a magnetic field oriented in the first direction and a magnetic field oriented in the second direction to be detected.

In a rotary machine (1; 1a; 1b) according to a fourth aspect, which may be implemented in conjunction with the third aspect, each of the plurality of the magnetoresistance effect elements (101, 102, 201, 202, 301, 302, 401, 402) is either a giant magnetoresistance effect element or a tunnel magnetoresistance effect element.

This aspect allows the position of the rotor (12) to be detected with more accuracy.

A rotary machine (1) according to a fifth aspect, which may be implemented in conjunction with any one of the first to fourth aspects, further includes a housing (15). The housing (15) houses at least the stator (11) and the rotor (12). The magnetic sensor (14) includes a sensor unit (142) and a board (141). The sensor unit (142) includes at least one magnetoresistance effect element (101, 102, 201, 202, 301, 302, 401, 402) disposed on a single plane (1423) of the sensor unit (142). The board (141) has one surface (1411). The sensor unit (142) is arranged on the one surface (1411) of the board (141) to make the single plane (1423) parallel to the one surface (1411) of the board (141). The housing (15) has a through hole (1522) penetrating through the housing (15) in the axial direction (D1). The magnetic sensor (14) is mounted onto the housing (15) by fixing the board (141) to the housing (15) in a state where the sensor unit (142) is located inside the housing (15) with the board (141) inserted at least partially into the through hole (1522).

This aspect allows the magnetic sensor (14) to be mounted onto the rotary machine (1) after the rotary machine (1) has been assembled as a final product.

A rotary machine (1) according to a sixth aspect, which may be implemented in conjunction with the fifth aspect, further includes a sealing member (16). The sealing member (16) seals the through hole (1522) with the magnetic sensor (14) mounted onto the housing (15).

This aspect may reduce the chances of foreign particles entering the housing (15).

A rotary machine (1a) according to a seventh aspect, which may be implemented in conjunction with any one of the first to fourth aspects, further includes a housing (15). The housing (15) houses at least the stator (11) and the rotor (12). The magnetic sensor (14a) includes a sensor unit (142) and a board (141). The sensor unit (142) includes at least one magnetoresistance effect element (101, 102, 201, 202, 301, 302, 401, 402) disposed on a single plane (1423) of the sensor unit (142). The board (141) has one surface (1411). The sensor unit (142) further includes an electrode portion (143) that electrically connects the sensor unit (142) and the board (141) to each other. The electrode portion (143) is disposed on a side surface (1424) extending, from an outer edge of the single plane (1423) of the sensor unit (142), in a direction intersecting with the single plane (1423). The board (141) is arranged inside the housing (15) to be parallel to a counter surface (1212), facing the magnetic sensor (14a), of the rotor (12). The sensor unit (142) is connected to the board (141) via the electrode portion (143).

According to this aspect, the counter surface (1212) of the rotor (12) and the single plane (1423) of the sensor unit (142) are perpendicular to each other, thus allowing the magnetic field generated by the plurality of magnets (122) of the rotor (12) to be detected as either a sinusoidal wave or a cosine wave.

A rotary machine (1b) according to an eighth aspect, which may be implemented in conjunction with any one of the first to fourth aspects, further includes a housing (15) and a holding member (145). The housing (15) houses at least the stator (11) and the rotor (12). The holding member (145) holds the magnetic sensor (14b). The magnetic sensor (14b) includes a sensor unit (142), a first board (144), and a second board (141). The sensor unit (142) includes at least one magnetoresistance effect element (101, 102, 201, 202, 301, 302, 401, 402) disposed on a single plane (1423) of the sensor unit (142). The first board (144) has one surface (1441). The first board (144) is connected to the second board (141). The first board (144) is a flexible board having flexibility in a thickness direction defined for the first board (144). The holding member (145) and the first board (144) are arranged to hold the sensor unit (142) such that a counter surface (1212), facing the magnetic sensor (14b), of the rotor (12) is perpendicular to the single plane (1423) of the sensor unit (142).

According to this aspect, the counter surface (1212) of the rotor (12) and the single plane (1423) of the sensor unit (142) are perpendicular to each other, thus allowing the magnetic field generated by the plurality of magnets (122) of the rotor (12) to be detected as either a sinusoidal wave or a cosine wave.

In a rotary machine (1b) according to a ninth aspect, which may be implemented in conjunction with the eighth aspect, the holding member (145) and the first board (144) are arranged to sandwich and hold the sensor unit (142) in an orthogonal direction (D2) that is perpendicular to the axial direction (D1).

According to this aspect, sandwiching the sensor unit (142) between the holding member (145) and the first board (144) allows the sensor unit (142) to be held.

In a rotary machine (1) according to a tenth aspect, which may be implemented in conjunction with any one of the fifth to ninth aspects, a center (C1) of the single plane (1423) of the sensor unit (142) is located, in the axial direction (D1), between a counter surface (1212), facing the magnetic sensor (14), of the rotor (12), and a first position (P1) where a distance (L2) from the counter surface (1212) is 0.8 times as long as a first value (L1). The first value (L1) is an external dimension of the rotor (12).

This aspect may improve the detection accuracy of the magnetic sensor (14).

In a rotary machine (1) according to an eleventh aspect, which may be implemented in conjunction with any one of the fifth to tenth aspects, a center (C1) of the single plane (1423) of the sensor unit (142) is located, in an orthogonal direction (D2) perpendicular to the axial direction (D1), between an outer edge of a counter surface (1212), facing the magnetic sensor (14), of the rotor (12) and a second position (P2) where a distance (L4) from the outer edge of the counter surface (1212) is 0.8 times as long as a second value (L3). The second value (L3) is a distance from the outer edge of the counter surface (1212) to the rotary shaft (13).

This aspect may improve the detection accuracy of the magnetic sensor (14).

A rotary machine (1; 1a; 1b) according to a twelfth aspect, which may be implemented in conjunction with any one of the first to eleventh aspects, is used as an electric motor.

This aspect allows the rotary machine (1; 1a; 1b) to be used as an electric motor.

A method for manufacturing a rotary machine (1; 1a; 1b) according to a thirteenth aspect is a method for manufacturing a rotary machine (1; 1a; 1b) including a stator (11), a rotor (12), a rotary shaft (13), and a magnetic sensor (14; 14a; 14b). The rotor (12) rotates relative to the stator (11). The rotary shaft (13) is coupled to the rotor (12) and rotates as the rotor (12) rotates. The magnetic sensor (14; 14a; 14b) detects a position of the rotor (12). The rotor (12) includes a plurality of magnets (122). The magnetic sensor (14; 14a; 14b) detects the position of the rotor (12) based on a magnetic field generated by the plurality of magnets (122) of the rotor (12). The method for manufacturing the rotary machine (1; 1a; 1b) includes the step of arranging the magnetic sensor (14; 14a; 14b) to make the magnetic sensor (14; 14a; 14b) face the rotor (12) in an axial direction (D1) parallel to the rotary shaft (13).

According to this aspect, the magnetic sensor (14; 14a; 14b) detects the position of the rotor (12) based on the magnetic field generated by the plurality of magnets (122) of the rotor (12), thus eliminating the need to provide any position detecting magnets.

A magnetic sensor (14; 14a: 14b) according to a fourteenth aspect is designed to be used in a rotary machine (1; 1a; 1b) including a stator (11), a rotor (12), and a rotary shaft (13). The rotor (12) rotates relative to the stator (11). The rotary shaft (13) is coupled to the rotor (12) and rotates as the rotor (12) rotates. The rotor (12) includes a plurality of magnets (122). The magnetic sensor (14; 14a; 14b) faces the rotor (12) in an axial direction (D1) parallel to the rotary shaft (13). The magnetic sensor (14; 14a; 14b) detects a position of the rotor (12) based on a magnetic field generated by the plurality of magnets (122) of the rotor (12).

According to this aspect, the magnetic sensor (14; 14a; 14b) detects the position of the rotor (12) based on the magnetic field generated by the plurality of magnets (122) of the rotor (12), thus eliminating the need to provide any position detecting magnets.

Note that the constituent elements according to the second to twelfth aspects are not essential constituent elements for the rotary machine (1; 1a; 1b) but may be omitted as appropriate.

### REFERENCE SIGNS LIST

1, 1a, 1b Rotary Machine
11 Stator
12 Rotor
122 Magnet
1212 Counter Surface
13 Rotary Shaft
14, 14a, 14b Magnetic Sensor
141 Board (Second Board)
1411 One Surface
142 Sensor Unit
1423 Single Plane (Plane)
1424 Side Surface
143 Electrode Portion
144 Board (First Board)
1441 One Surface
145 Holding Member
101, 102, 301, 302 Magnetoresistance Effect Element (First Magnetoresistance Effect Element)
201, 202, 401, 402 Magnetoresistance Effect Element (Second Magnetoresistance Effect Element)
15 Housing
1522 Through Hole
16 Sealing Member
C1 Center
D1 Axial Direction
D2 Orthogonal Direction
L1 First Value
L2, L4 Distance
L3 Second Value
P1 First Position
P2 Second Position

1. A rotary machine comprising:
a stator;
a rotor configured to rotate relative to the stator;
a rotary shaft coupled to the rotor and configured to rotate as the rotor rotates; and
a magnetic sensor configured to detect a position of the rotor,
the rotor including a plurality of magnets,
the magnetic sensor being arranged to face the rotor in an axial direction that is parallel to the rotary shaft, and
the magnetic sensor being configured to detect the position of the rotor based on a magnetic field generated by the plurality of magnets of the rotor.

2. The rotary machine of claim 1, wherein
the magnetic sensor includes at least one magnetoresistance effect element disposed on a single plane of the magnetic sensor, and
a counter surface, facing the magnetic sensor, of the rotor and the single plane of the magnetic sensor are perpendicular to each other.

3. The rotary machine of claim 2, comprising a plurality of the magnetoresistance effect elements, wherein
the plurality of the magnetoresistance effect elements includes:
a first magnetoresistance effect element configured to detect a magnetic field oriented in a first direction, the first direction being perpendicular to the single plane of the magnetic sensor; and
a second magnetoresistance effect element configured to detect a magnetic field oriented in a second direction, the second direction being perpendicular to not only the single plane of the magnetic sensor but also the first direction.

4. The rotary machine of claim 3, wherein
each of the plurality of the magnetoresistance effect elements is either a giant magnetoresistance effect element or a tunnel magnetoresistance effect element.

5. The rotary machine of claim 1, further comprising a housing that houses at least the stator and the rotor, wherein
the magnetic sensor includes:
a sensor unit including at least one magnetoresistance effect element disposed on a single plane of the sensor unit; and
a board having one surface,
the sensor unit is arranged on the one surface of the board to make the single plane parallel to the one surface of the board,
the housing has a through hole penetrating through the housing in the axial direction, and
the magnetic sensor is mounted onto the housing by fixing the board to the housing in a state where the sensor unit is located inside the housing with the board inserted at least partially into the through hole.

6. The rotary machine of claim 5, further comprising a sealing member that seals the through hole with the magnetic sensor mounted onto the housing.

7. The rotary machine of claim 1, further comprising a housing that houses at least the stator and the rotor, wherein
the magnetic sensor includes:
a sensor unit including at least one magnetoresistance effect element disposed on a single plane of the sensor unit; and
a board having one surface,
the sensor unit further includes an electrode portion that electrically connects the sensor unit and the board to each other,
the electrode portion is disposed on a side surface extending, from an outer edge of the single plane of the sensor unit, in a direction intersecting with the single plane,
the board is arranged inside the housing to be parallel to a counter surface, facing the magnetic sensor, of the rotor, and
the sensor unit is connected to the board via the electrode portion.

8. The rotary machine of claim 1, further comprising:
a housing that houses at least the stator and the rotor; and
a holding member that holds the magnetic sensor, wherein
the magnetic sensor includes:
a sensor unit including at least one magnetoresistance effect element disposed on a single plane of the sensor unit;
a first board having one surface; and
a second board to which the first board is connected,
the first board is a flexible board having flexibility in a thickness direction defined for the first board, and
the holding member and the first board are arranged to hold the sensor unit such that a counter surface, facing the magnetic sensor, of the rotor is perpendicular to the single plane of the sensor unit.

9. The rotary machine of claim 8, wherein
the holding member and the first board are arranged to sandwich and hold the sensor unit in an orthogonal direction perpendicular to the axial direction.

10. The rotary machine of claim 5, wherein
a center of the single plane of the sensor unit is located, in the axial direction, between a counter surface, facing the magnetic sensor, of the rotor and a first position where a distance from the counter surface is 0.8 times as long as a first value, the first value being an external dimension of the rotor.

11. The rotary machine of claim 5, wherein
a center of the single plane of the sensor unit is located, in an orthogonal direction perpendicular to the axial direction, between an outer edge of a counter surface, facing the magnetic sensor, of the rotor and a second position where a distance from the outer edge of the counter surface is 0.8 times as long as a second value, the second value being a distance from the outer edge of the counter surface to the rotary shaft.

12. The rotary machine of claim 1, wherein
the rotary machine is used as an electric motor.

13. A method for manufacturing a rotary machine, the rotary machine comprising:
a stator;
a rotor configured to rotate relative to the stator;
a rotary shaft coupled to the rotor and configured to rotate as the rotor rotates; and
a magnetic sensor configured to detect a position of the rotor,
the rotor including a plurality of magnets,
the magnetic sensor being configured to detect the position of the rotor based on a magnetic field generated by the plurality of magnets of the rotor,
the method comprising the step of arranging the magnetic sensor to make the magnetic sensor face the rotor in an axial direction that is parallel to the rotary shaft.

14. A magnetic sensor for use in a rotary machine, the rotary machine comprising:
a stator;
a rotor configured to rotate relative to the stator; and
a rotary shaft coupled to the rotor and configured to rotate as the rotor rotates,
the rotor including a plurality of magnets,
the magnetic sensor facing the rotor in an axial direction parallel to the rotary shaft, and
the magnetic sensor being configured to detect a position of the rotor based on a magnetic field generated by the plurality of magnets of the rotor.
